(19) United States
(12) Patent Application Publication
(10) Pub. No.: US 2017/0277528 A1
(43) Pub. Date: Sep. 28, 2017

(54) APPLICATION INSTALLATION SYSTEM AND METHOD FOR HANDHELD DEVICES

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Ning MA, Beijing (CN)

(73) Assignees: LE HOLDINGS (BEIJING) CO., LTD., Beijing (CN); LEMOBILE INFORMATION TECHNOLOGY (BEIJING) CO., LTD, Beijing (CN)

(21) Appl. No.: 15/242,070

(22) Filed: Aug. 19, 2016

Related U.S. Application Data
(63) Continuation of application No. PCT/CN2016/089561, filed on Jul. 10, 2016.

(30) Foreign Application Priority Data
Mar. 28, 2016 (CN) 201610181989.X

(51) Int. Cl. G06F 9/445

(52) U.S. Cl. CPC G06F 8/62; G06F 8/61; H04L 67/34

(57) ABSTRACT

Embodiments of the present invention relate to the field of disclosure installing technologies of a handheld device, and disclose a disclosure installing system and method for a handheld device and an electronic device. The system includes: a receiving module, configured to receive a memory space size needed by a new disclosure; a detecting module, configured to detect whether a remaining space size of the handheld device meets the memory space size needed by the new disclosure; and a processing module, which installs the new disclosure when the detection result of the detecting module is that the remaining space size of the handheld device meets the memory space size needed by the new disclosure, and uninstalls one or more disclosures installed on the handheld device when the detection result indicates that the remaining space size of the handheld device does not meet the memory space size needed by the new disclosure.

### CROSS-REFERENCE TO RELATED APPLICATIONS

The present disclosure is a continuation application of PCT application No. PCT/CN2016/089561 submitted on Jul. 10, 2016. The present disclosure is based upon and claims priority to Chinese Patent Application No. 201610181989.X, filed before Chinese Patent Office on Mar. 28, 2016 and entitled “APPLICATION INSTALLING SYSTEM AND METHOD FOR HANDHELD DEVICE”, the entire contents of which are incorporated herein by reference.

### TECHNICAL FIELD

This patent disclosure relates to application installing technologies of handheld devices, and more particularly, to an application installing method for a handheld device and an electronic device.

### BACKGROUND

Currently, the memory capacity of a handheld device is generally 16 G, 32 G, 64 G, or 128 G, and the 8 G-version that is common before faces elimination because the memory capacity cannot meet the use requirements of users. In a process of using a handheld device, a user installs a lot of disclosures. Some of the applications are frequently used and are used every day, but some are seldom used, and are used only once since installation. However, installing too many disclosures causes insufficient memory of the handheld device, and new disclosures cannot be installed any more. It undoubtedly brings troubles to the user if the user searches, in the handheld device, for disclosures to be uninstalled when the handheld device prompts the user that installation cannot be performed due to the insufficient memory, and therefore, the degree of user experience is not great.

### SUMMARY

An objective of some embodiments of the present invention is to provide a disclosure installing system and method for a handheld device, for resolving the problem of automatically selecting and uninstalling disclosures installed on the handheld device so as to install a new program when installation cannot be performed due to an insufficient memory of the handheld device.

According to a first aspect, some embodiments of the present invention further provide a disclosure installing method for a handheld device, including: receiving a memory space size needed by a new disclosure; detecting whether a remaining space size of the handheld device meets the memory space size needed by the new disclosure; and installing the new disclosure when the detection result indicates that the remaining space size of the handheld device meets the memory space size needed by the new disclosure, and uninstalling one or more disclosures installed on the handheld device when the detection result indicates that the remaining space size of the handheld device does not meet the memory space size needed by the new disclosure, such that the remaining space size of the handheld device meets the memory space size needed by the new disclosure.

In one embodiment, the uninstalling one or more disclosures installed on the handheld device includes: uninstalling one or more disclosures according to an ascending use frequency sequence; and/or uninstalling one or more disclosures, which are not in the whitelist, on the handheld device.

In one embodiment, the method further includes: storing basic data of the uninstalled disclosures, where the basic data includes icons, download links, and stored data of the uninstalled disclosures.

In one embodiment, the method further includes: downloading the corresponding disclosures via the download links when the icons of the uninstalled disclosures are clicked, and loading the corresponding stored data to the disclosures.

In one embodiment, the method further includes: when the detection result indicates that the remaining space size of the handheld device does not meet the memory space size needed by the new disclosure, displaying a list of all disclosures installed on the handheld device; receiving uninstalled disclosure selection information indicating the disclosures to be uninstalled; and uninstalling the corresponding disclosures according to the uninstalled disclosure selection information.

According to a second aspect, an embodiment of the disclosure further provides a non-transitory computer-readable storage medium, which stores computer executable instructions, where the computer executable instructions can be executed to perform any one of the mentioned methods for installing method for a handheld device of this disclosure.

According to a third aspect, an embodiment of the disclosure further provides an electronic device, including: at least one processor; and a memory in communication connection with the at least one processor. The memory stores instructions that can be executed by the at least one processor, and execution of the instructions by the at least one processor, causes the at least one processor to perform any foregoing method for installing method for a handheld device of this disclosure.

With the above technical solutions, in the present invention, by detecting whether a remaining space size of a handheld device meets a memory space size needed by a new disclosure, and uninstalling disclosures installed on the handheld device when the remaining space size of the handheld device does not meet the memory space size needed by the new disclosure, uninstallation of the installed disclosures and installation of the new disclosure can be automatically performed without user awareness, thereby resolving the problem that the new disclosure cannot be installed due to an insufficient memory of the handheld device.

Other characteristics and advantages of the present invention are described in detail in a subsequent part of specific implementation manners.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed. In the accompanying drawings:

FIG. 1 is a block diagram illustrating a disclosure installing system for a handheld device according to an embodiment of the present invention;

FIG. 2 is a diagram illustrating a disclosure installing process for a handheld device according to an embodiment of the present invention;

FIG. 3 is a flowchart illustrating a disclosure installing method for a handheld device according to an embodiment of the present invention; and

FIG. 4 is a schematic structural diagram of hardware of an electronic device for executing a disclosure installing method for a handheld device provided in another embodiment of this disclosure.

### DETAILED DESCRIPTION

Specific embodiments of the present invention are described hereinafter in detail with reference to the accompanying drawings. It should be understood that the specific embodiments described hereinafter are merely used for describing and explaining the present invention, but are not intended to limit the present invention.

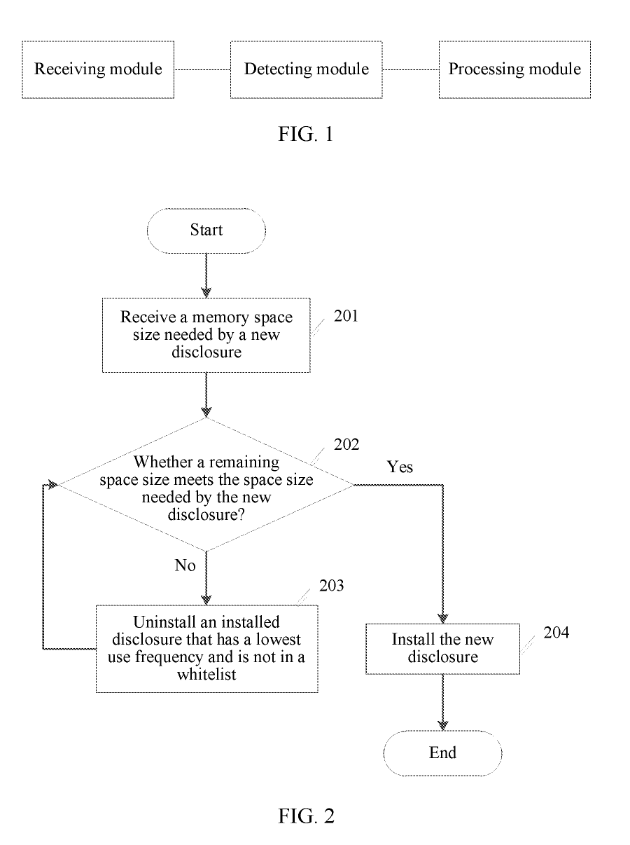

FIG. 1 is a block diagram of a disclosure installing system for a handheld device according to an embodiment of the present invention. As illustrated in FIG. 1, the system includes a receiving module, a detecting module, and a processing module. The receiving module is configured to receive a memory space size needed by a new disclosure; the detecting module is configured to detect whether a remaining space size of the handheld device meets the memory space size needed by the new disclosure; and the processing module installs the new disclosure when the detection result of the detecting module is that the remaining space size of the handheld device meets the memory space size needed by the new disclosure, and uninstalls one or more disclosures installed on the handheld device when the detection result indicates that the remaining space size of the handheld device does not meet the memory space size needed by the new disclosure, such that the remaining space size of the handheld device meets the memory space size needed by the new disclosure.

A precondition of technical solutions according to some embodiments of the present invention is that a user selects, by using the handheld device, a disclosure to be downloaded and determines to download the disclosure, where the disclosure is the new disclosure herein. With the technical solutions according to the present invention, when the user expects to download a new disclosure by using the handheld device, the detecting module detects the memory space size needed by the new disclosure to be downloaded, and detects the remaining space size of the handheld device, which are both conventional technologies in the art. If it is detected that the remaining space size of the handheld device does not meet the memory space size needed by the new disclosure, that is, the remaining space size of the handheld device is less than the memory space size needed by the new disclosure, then the new disclosure cannot be installed. In this case, in the prior art, the user is prompted, by using a display module, that installation cannot be performed, and there is no further processing manner. The technical solutions according to the present invention are an improvement on this aspect of the prior art.

With the technical solutions according to some embodiments of the present invention, if it is detected that the remaining space size of the handheld device does not meet the memory space size needed by the new disclosure, disclosures installed on the handheld device are automatically uninstalled, so as to enable the remaining space size of the handheld device to meet the memory space size needed by the new disclosure. The number of the uninstalled disclosure(s) may be one or more, depending on actual situations. One disclosure is uninstalled if the remaining space size of the handheld device can meet the memory space size needed by the new disclosure by uninstalling one disclosure; and if the remaining space size of the handheld device still cannot meet the memory space size needed by the new disclosure by uninstalling one disclosure, one more disclosure needs to be uninstalled (that is, multiple disclosures are uninstalled), until the remaining space size of the handheld device meets the memory space size needed by the new disclosure.

With respect to which installed disclosures to be uninstalled, persons skilled in the art should understand that priority should be given to disclosures with low use frequencies. However, this is not absolute because although some disclosures are not frequently used, the user still does not expect to uninstall the disclosures. Therefore, uninstalling one or more disclosures installed on the handheld device, as described above includes: uninstalling one or more disclosures according to an ascending use frequency sequence; and/or uninstalling one or more disclosures, which are not in a whitelist, on the handheld device.

Two manners for uninstalling the disclosures installed on the handled device are provided herein. For the first manner, that is, uninstalling one or more disclosures according to an ascending use frequency sequence, statistics are collected for a use frequency of each disclosure on the current handheld device. When the processing module needs to uninstall the disclosures installed on the handheld device, a disclosure with a lowest use frequency among all the installed disclosures may be uninstalled; and if there are multiple disclosures with the lowest use frequency, uninstallation is performed according to an arrangement sequence of the multiple disclosures, for example, according to an alphabetical order or a download sequence. For the first manner, that is, uninstalling one or more disclosures, which are not in the whitelist, on the handheld device, some disclosures are not frequently used by the user, but the user does not expect to uninstall the disclosures, and then these disclosures may be added to the whitelist; or some disclosures that the manufacturer, for the objective of promotion, does not expect the user to uninstall can also be added to the whitelist in factory settings; in this way, the disclosures listed in the whitelist are not uninstalled when the processing module automatically uninstalls the disclosures installed on the handheld device. The above two manners can be used separately or in combination. A case of using the two manners in combination is, for example, when the processing module automatically uninstalls the disclosures installed on the handheld device, the disclosures listed in the whitelist are first excluded, and the disclosures except the disclosures listed in the whitelist are sorted; a sorting manner may be sorting according to an ascending use frequency sequence, that is, a disclosure with a lowest use frequency among the disclosures except the disclosures in the whitelist is uninstalled. Rules for adding disclosures to the whitelist may be diversified: the rules may be set by the user himself, as mentioned above, or may be set by the manufacturer in factory settings; and in addition, disclosures with use frequencies greater than a threshold may be automatically added to the whitelist, and the like.

The disclosure installing system according to some embodiments of the present invention further includes a storage module. The storage module is configured to store basic data of the uninstalled disclosures, where the basic data may include but is not limited to icons, download links, and stored data of the uninstalled disclosures. An objective of storing the basic data is to keep, on the handheld device, the icons of the uninstalled disclosures, data generated when the user uses the disclosures, and data needed for downloading the disclosures (for example, the download links).

Correspondingly, the processing module is further configured to download the corresponding disclosures via the download links when the icons of the uninstalled disclosures are clicked, and load the corresponding stored data to the disclosures. It can be seen that an objective of storing the basic data by the storage module is to facilitate re-downloading of the uninstalled disclosures. If the basic data is stored, the processing module can automatically download the disclosures when the icons of the uninstalled disclosures are clicked (substantively, the processing module receives a click message), while the user does not need to search and download the disclosures again in a disclosure store. That is, after a disclosure is uninstalled, an icon thereof still remains on a desktop (substantively, other basic data in addition to the icon is kept in a background). When the user clicks a disclosure after the disclosure is uninstalled, the processing module automatically voluntarily downloads the disclosure from a corresponding website (for example, the disclosure store) according to the basic data of the disclosure (specifically, a download link) and restores information related to the disclosure (specifically, the stored data), such that the disclosure can run normally. The entire process does not need participation of the user and is completed in the background by using the handheld device. Certainly, when a disclosure that has been uninstalled is re-downloaded, the problem that the remaining space size of the handheld device does not meet the memory space size needed by the disclosure may also occur. If the problem occurs, this disclosure is used as the new disclosure described in the present invention, and is downloaded and installed according to the technical solutions according to the present invention.

The disclosure installing system according to some embodiments of the present invention further includes a display module, where when the detection result indicates that the remaining space size of the handheld device does not meet the memory space size needed by the new disclosure, the processing module displays, by using the display module, a list of all disclosures installed on the handheld device; and the receiving module is further configured to receive uninstalled disclosure selection information indicating the disclosures to be uninstalled, where the processing module uninstalls the corresponding disclosures according to the uninstalled disclosure selection information.

Specifically, when the detecting module detects that the remaining space size of the handheld device does not meet the memory space size needed by the new disclosure, the processing module does not immediately automatically uninstall the disclosures installed on the handheld device, instead, notifies the user of the case by using the display module (a step of notifying the user that an insufficient space is same as that in the prior art) and displays the list of all disclosures currently installed on the handheld device to the user, such that the user selects the disclosures to be uninstalled. Subsequently, the processing module uninstalls the disclosures selected by the user and stores the basic information of the uninstalled disclosures.

The disclosure list displayed by using the display module may be the list of all disclosures installed on the handheld device, as described above; or may be a list of the disclosures except those in the whitelist. The displayed disclosures may be sorted according to download time, or according to use frequencies.

FIG. 2 is a diagram illustrating a disclosure installing process of a handheld device according to an embodiment of the present invention. As illustrated in FIG.2, the process includes:

Step 201: A receiving module receives a memory space size needed by a new disclosure.

Step 202: A detecting module detects whether a remaining space size of the handheld device meets the space size needed by the new disclosure; if the determining result indicates that the remaining space size of the handheld device meets the space size needed by the new disclosure, the remaining space size of the handheld device meets the space size needed by the new disclosure, and step 204 is performed; and if the determining result indicates that the remaining space size of the handheld device does not meet the space size needed by the new disclosure, the remaining space size of the handheld device does not meet the space size needed by the new disclosure, that is, the new disclosure cannot be installed, and step 203 is performed.

Step 203: A processing module uninstalls an installed disclosure that has a lowest use frequency and is not in a whitelist; this is merely one implementation manner of the present invention. Other implementation manners are described above, and details are not further described herein again. After the installed disclosure is uninstalled, the process returns to step 202 to determine again whether the remaining space size of the handheld device meets the space size needed by the new disclosure. Herein, no matter whether one or more disclosures need to be uninstalled to enable the remaining space size of the handheld device to meet the space size needed by the new disclosure, step 202 needs to be returned to each time one disclosure is uninstalled to determine again whether the remaining space size of the handheld device meets the space size needed by the new disclosure; and

Step 204: The new disclosure is installed.

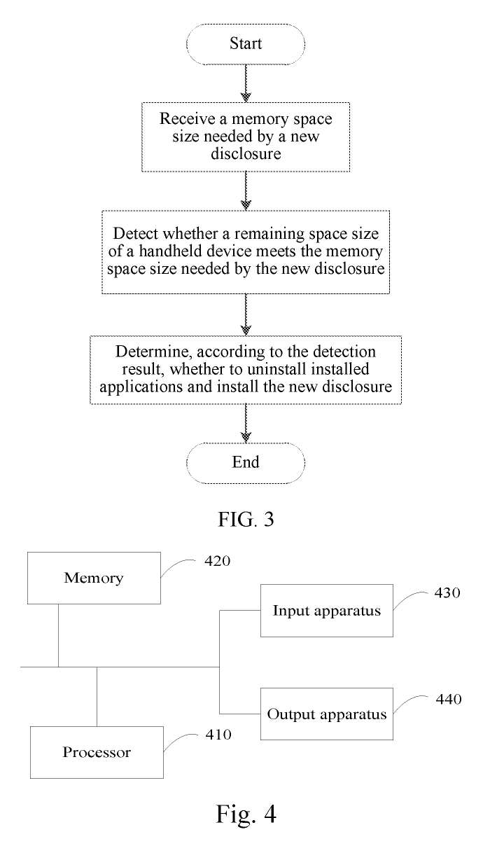

FIG. 3 is a flowchart illustrating a disclosure installing method for a handheld device according to an embodiment of the present invention. As illustrated in FIG. 3, the method includes: receiving a memory space size needed by a new disclosure; detecting whether a remaining space size of the handheld device meets the memory space size needed by the new disclosure; and installing the new disclosure when the detection result indicates that the remaining space size of the handheld device meets the memory space size needed by the new disclosure, and uninstalling one or more disclosures installed on the handheld device when the detection result indicates that the remaining space size of the handheld device does not meet the memory space size needed by the new disclosure, such that the remaining space size of the handheld device meets the memory space size needed by the new disclosure.

It should be noted that the specific details and benefits of the disclosure installing method for a handheld device according to the present invention are similar to those of the disclosure installing system for a handheld device according to the present invention, and details are not further described herein again.

According to an embodiment of the present disclosure, there is provided with a non-transitory computer-readable storage medium storing executable instructions that, when executed by an electronic device, cause the electronic device to perform installing method for a handheld device in any one of the foregoing method embodiments.

FIG. 4 illustrates a schematic hardware diagram of an electronic device for performing installing method for a handheld device provided in another embodiment of this disclosure. As shown in FIG. 4, the electronic device includes: one or more processors 410 and a memory 420, FIG. 4 shows one processor 410 as an example.

A device for executing the disclosure installing method for a handheld device can further include: an input apparatus 430 and an output apparatus 440.

The processor 410, the memory 420, the input apparatus 430, and the output apparatus 440 can be connected by means of a bus or in other manners. A connection by means of a bus is used as an example in FIG. 4.

Memory 420 is a non-transitory computer-readable medium for storing a non-transitory software program, a non-transitory computer-readable program and module, for example the program instructions/module for performing installing method for a handheld device in the embodiments of this disclosure (for example. the receiving module, the detection module, and the processing module shown in FIG. 1). The processor 410 can operate the various functions and data processing of a server to perform installing method for a handheld device of the foregoing method embodiments by executing non-transitory software programs, instructions and modules stored in the memory 420.

The memory 420 can include a program storage area and a data storage area. Among them, the program storage area may store operation system, application programs of at least one function; the data storage area may store generated data during operation of the electronic apparatus for performing installing apparatus for a handheld device, and the like. In addition, the memory 420 may include a high speed random access memory, and a non-transitory storage medium, for example at least one disk storage device, flash storage device, or another non-transitory solid-state storage device. In some embodiments, the memory 420 may include a storage medium that is remote to the processor 410. The remote storage medium may be connected, via a network, to the disclosure installing apparatus for a handheld device. The examples of such as network include but not limited to Internet, enterprise intranet, local area network, mobile telecommunication network and a combination thereof.

The input apparatus 430 can receive input number or byte information, and can generate input key information relating to user setting and functional control of the electronic apparatus for performing the installing apparatus for a handheld device described in the above embodiments. The output apparatus 440 may include a display device such as a display screen.

The one or more modules stored in the memory 420 that, when executed by the one or more processors 410, can perform installing method for a handheld device in any one of the foregoing method embodiments.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:

A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

A super-mobile personal computer which belongs to the field of a personal computer and has calculation and processing functions, and in general can access to a mobile network. Such a terminal device includes: a PDA, a MID and a UMPC etc., for example iPad.

A portable entertainment device which is capable of displaying and playing multimedia content. Such a device includes: an audio player, a video player (e.g. iPod), a handheld game console, an electronic book, a smart toy and a portable automotive navigation device.

A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. An application installing method for a handheld device, applied in a terminal, comprising:
receiving a memory space size needed by a new application;
detecting whether a remaining space size of the handheld device meets the memory space size needed by the new application; and
installing the new application when the detection result indicates that the remaining space size of the handheld device meets the memory space size needed by the new application, and uninstalling one or more applications installed on the handheld device when the detection result indicates that the remaining space size of the handheld device does not meet the memory space size needed by the new application, such that the remaining space size of the handheld device meets the memory space size needed by the new application.

2. The method according to claim 1, wherein the uninstalling one or more applications installed on the handheld device comprises:
uninstalling one or more applications according to an ascending use frequency sequence; and/or
uninstalling one or more applications, which are not in the whitelist, on the handheld device.

3. The method according to claim 1, further comprising:
storing basic data of the uninstalled applications, wherein the basic data comprises icons, download links, and stored data of the uninstalled applications.

4. The method according to claim 1, further comprising:
downloading the corresponding applications via the download links when the icons of the uninstalled applications are clicked, and loading the corresponding stored data to the applications.

5. The method according to claim 1, further comprising:
when the detection result indicates that the remaining space size of the handheld device does not meet the memory space size needed by the new application, displaying a list of all applications installed on the handheld device;
receiving uninstalled application selection information indicating the applications to be uninstalled; and
uninstalling the corresponding applications according to the uninstalled application selection information.

6. A non-transitory computer-readable storage medium, which stores a computer executable instructions, where the computer executable instructions are configured to:
receive a memory space size needed by a new application;
detect whether a remaining space size of the handheld device meets the memory space size needed by the new application; and
install the new application in a case in which the detection result is that the remaining space size of the handheld device meets the memory space size needed by the new application, and uninstall one or more applications installed on the handheld device in a case in which the detection result is that the remaining space size of the handheld device does not meet the memory space size needed by the new application, thereby enabling the remaining space size of the handheld device to meet the memory space size needed by the new application.

7. The non-transitory computer-readable storage medium according to claim 6, wherein to uninstall one or more applications installed on the handheld device the computer executable instructions are configured to:
uninstall one or more applications according to an ascending use frequency sequence; and/or
uninstall one or more applications, which are not in the whitelist, on the handheld device.

8. The non-transitory computer-readable storage medium according to claim 6, the computer executable instructions are further configured to:
store basic data of the uninstalled applications, wherein the basic data comprises icons, download links, and stored data of the uninstalled applications.

9. The non-transitory computer-readable storage medium according to claim 6, the computer executable instructions are further configured to:
download, in a case in which the icons of the uninstalled applications are clicked, the corresponding applications by using the download links, and load the corresponding stored data to the applications.

10. The non-transitory computer-readable storage medium according to claim 6, the computer executable instructions are further configured to:
when the detection result is that the remaining space size of the handheld device does not meet the memory space size needed by the new application, display a list of all applications installed on the handheld device;
receive uninstalled application selection information indicating the applications to be uninstalled; and
uninstall the corresponding applications according to the uninstalled application selection information.

11. An electronic device, comprising:
at least one processor; and
a memory communicably connected with the at least one processor for storing instructions executable by the at least one processor, where execution of the instructions by the at least one processor causes the at least one processor to :
receive a memory space size needed by a new application;
detect whether a remaining space size of the handheld device meets the memory space size needed by the new application; and
install the new application in a case in which the detection result is that the remaining space size of the handheld device meets the memory space size needed by the new application, and uninstalling one or more applications installed on the handheld device in a case in which the detection result is that the remaining space size of the handheld device does not meet the memory space size needed by the new application, thereby enabling the remaining space size of the handheld device to meet the memory space size needed by the new application.

12. The electronic device according to claim 11, wherein to uninstall one or more applications installed on the handheld device the at least one processor is caused to:
uninstall one or more applications according to an ascending use frequency sequence; and/or
uninstall one or more applications, which are not in the whitelist, on the handheld device.

13. The electronic device according to claim 11, the at least one processor is further caused to:
store basic data of the uninstalled applications, wherein the basic data comprises icons, download links, and stored data of the uninstalled applications.

14. The electronic device according to claim 11, the at least one processor is further caused to:
download, in a case in which the icons of the uninstalled applications are clicked, the corresponding applications by using the download links, and load the corresponding stored data to the applications.

15. The electronic device according to claim 11, the at least one processor is further caused to:
when the detection result is that the remaining space size of the handheld device does not meet the memory space size needed by the new application, displaying a list of all application s installed on the handheld device;
receive uninstalled application selection information indicating the applications to be uninstalled; and
uninstall the corresponding applications according to the uninstalled application selection information.
